(19) United States
(12) Patent Application Publication
(10) Pub. No.: US 2011/0271877 A1
(43) Pub. Date: Nov. 10, 2011

(54) ADAPTOR DEVICE AND CUTTING BOARD FOR PROTECTIVELY MOUNTING A HAND-CRANK DEVICE TO A COUNTERTOP OR TABLETOP

(76) Inventor: Dominic Frisina, Meadville, PA (US)

(21) Appl. No.: 12/773,820

(22) Filed: May 4, 2010

(51) Int. Cl. A47B 96/18; F16M 13/02

(52) U.S. Cl. 108/42; 248/201; 108/65

(57) ABSTRACT

The present invention generally relates to a protective device for mounting to a tabletop or countertop. Some embodiments comprise a slab member having at least three corner regions, the slab member being adapted to overlay at least a portion of a tabletop or countertop. Some embodiments may also comprise a plurality of position-fixing members disposed at a plurality of the at least three corner regions, wherein the position-fixing members are adapted to fixedly engage the slab member with the tabletop or countertop in a fixed relation. Some embodiments may also include an adapter region comprising a portion of the peripheral area of the slab member disposed between one or more of the plurality of position-fixing members and one or more peripheral edges of the slab member, wherein the adapter region is configured to receive a mountable food preparation device in a clamping relation.

### I. BACKGROUND OF THE INVENTION

A. Field of Invention

This invention generally relates to devices for protecting countertops and/or tabletops.

B. Description of the Related Art

It is well known to use hand-cranked devices in, for instance, kitchens or food preparation areas for any of a wide variety of purposes including cheese grating, meat grinding, sausage pressing, and the like. Such devices often must be mounted with one or more clamps to a tabletop or countertop to prevent slippage and/or fix the device in an operable orientation. However, clamps may scratch, blemish, or otherwise damage the countertop or tabletop. Furthermore, often use of a hand-cranked device is done in connection with the use of a cutting board. For instance, items to be placed in a hand-crank grinder may need to be cut into smaller sizes that can be received by the grinder's hopper. Therefore, it is desirable to avoid having exposed countertop or tabletop surface between the cutting area and the hand-crank device to minimize mess.

What is needed is a protective device having a cutting board portion and an adaptor portion configured to receive a hand-crank device in a clamping relation, wherein the protective device can be mounted to a countertop or tabletop without damaging it. Some embodiments of the present invention may provide one or more of these features.

### II. SUMMARY OF THE INVENTION

Some embodiments of the present invention relate to a protective device for mounting to a tabletop or countertop, comprising: a slab member having at least three corner regions, the slab member being adapted to overlay at least a portion of a tabletop or countertop; a plurality of clamping members receivable by a plurality of the at least three corner regions, wherein the clamping members are adapted to fixedly engage the slab member with the tabletop or countertop in a clamping relation; an adapter region comprising a portion of the peripheral area of the slab member disposed between one or more of the plurality of clamping members and one or more peripheral edges of the slab member, wherein the adapter region is configured to receive a mountable food preparation device in a clamping relation; and a cutting region comprising a portion of the slab member adjacent to the adapter region, wherein the cutting region is configured to receive one or more blades in a cutting relation while protecting the underlying tabletop or countertop from the one or more blades.

Some embodiments relate to a protective device for mounting to a tabletop or countertop, comprising: a slab member having at least three corner regions, the slab member being adapted to overlay at least a portion of a tabletop or countertop in a protective relation; a means for fixedly engaging the slab member with the tabletop or countertop; and a means for the slab member to receive a mountable food preparation device in a fixed relation.

Some embodiment relate to a protective device for mounting to a tabletop or countertop, comprising: a slab member having at least three corner regions, the slab member being adapted to overlay at least a portion of a tabletop or countertop; a plurality of position-fixing members disposed at a plurality of the at least three corner regions, wherein the position-fixing members are adapted to fixedly engage the slab member with the tabletop or countertop in a fixed relation; and an adapter region comprising a portion of the peripheral area of the slab member disposed between one or more of the plurality of position-fixing members and one or more peripheral edges of the slab member, wherein the adapter region is configured to receive a mountable food preparation device in a clamping relation.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of an embodiment;

FIG. 2 is a side view of the embodiment of FIG. 1 taken along line 2-2; and

FIG. 3 is a perspective view of the embodiment of FIG. 1 with a hand-crank grinder installed.

### IV. DETAILED DESCRIPTION OF THE INVENTION

The present invention generally relates to devices and methods for protecting kitchen countertops and/or tabletops. For example, some embodiments include a generally planar slab member defining an adaptor region configured to receive a kitchen or food preparation device in a clamping relation, and a plurality of position-fixing members adapted to engage a countertop or tabletop in a fixed relation. Some embodiments further include a cutting region configured to receive one or more blades in a cutting relation while protecting the underlying tabletop or countertop from the one or more blades.

According to one embodiment a cutting region can include a generally planar portion, and/or may optionally include one or more contoured portions adapted to perform functions such as, without limitation, collecting and/or directing the flow of fluids, holding items to be cut and/or items that have been cut, straining, or draining. For example, in some embodiments a cutting region can define a corrugated surface adapted to receive liquid from, for instance, wet foods and direct the liquid away from the food and/or cutting region. In some embodiments, the cutting region can include or be surrounded by a groove for collecting such liquids.

In some embodiments the slab member can comprise in of a variety of materials known in the art. Such materials may include one or more of, without limitation, wood, butcher-block, polyethylene, polypropylene, high-density polyethylene, tetrafluoroethylene, polycarbonate, and polyethyleneterephthalate. According to some embodiments, the slab member can define a generally rectangular, triangular, or irregular shape, or any combination thereof.

According to some embodiments the position fixing members can comprise any of a wide variety of devices adapted to engage a slab in a fixed relation with a tabletop or countertop. For example, some suitable position fixing devices include, without limitation, a threaded L-clamp, a C-clamp, and a toggle clamp. In some embodiments one or more clamps are disposed on a face of the slab member near one or more edges thereof. According to such embodiments, the space between the clamps and the peripheral edges of the slab defines an adaptor region that is suitable for fixedly engaging a mountable food preparation device in a clamping relation. Further according to such embodiments the adaptor region is adapted to extend beyond the edge of the tabletop or countertop thereby making it available to be received by one or more mounts disposed on the food preparation device.

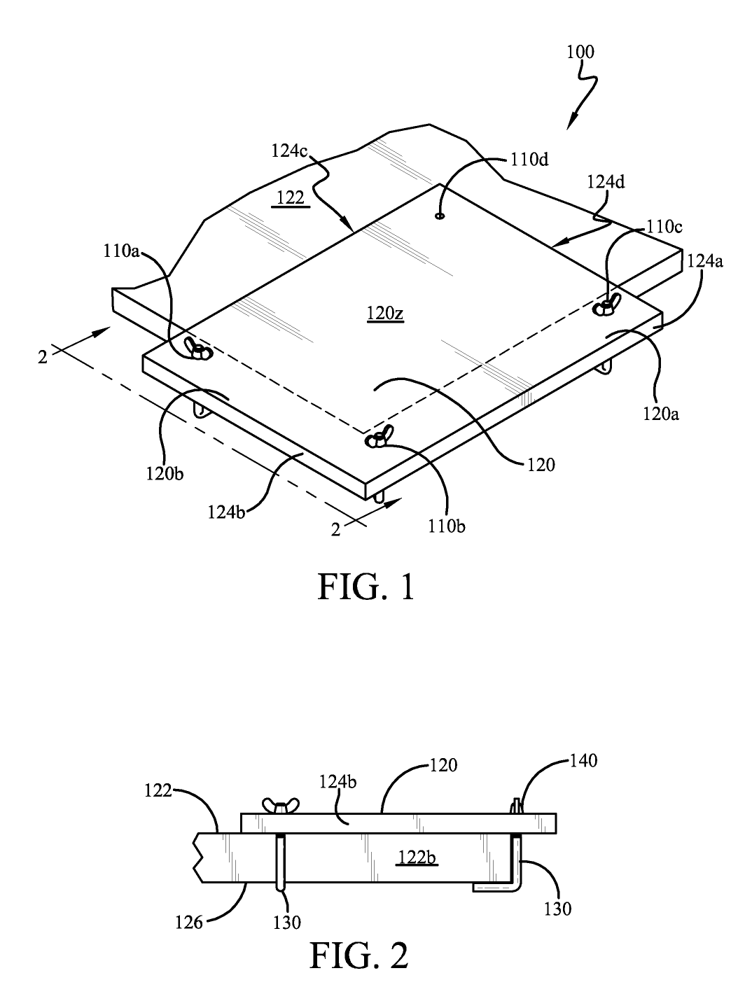

Referring now to the drawings, which are only for purposes of illustrating embodiments of the invention and are not intended to limit the same, FIG. 1 is a perspective view of an embodiment 100 of the invention mounted to a tabletop or countertop 122. This embodiment 100 comprises a slab member 120 defining a generally rectangular shape. The slab member 120 further defines four through-holes (110a, 110b, 110c, and 110d) disposed in each of four corner regions of the slab member 120.

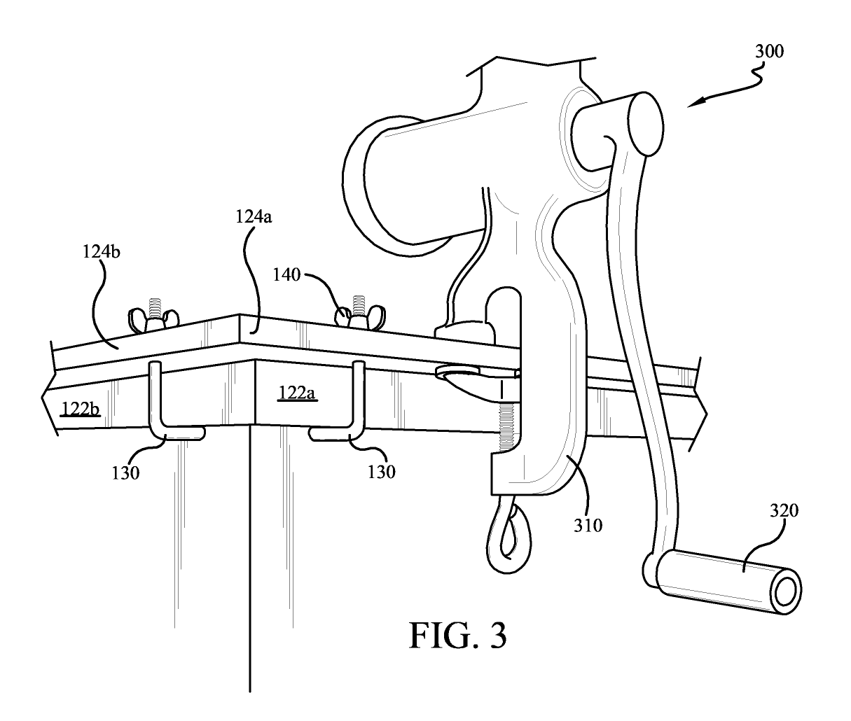

FIG. 2 is a drawing of the embodiment of FIG. 1 as shown along line 2-2. According to this embodiment, the through-holes 110a-d are each configured to receive a threaded L-clamp 130 in a slidable relation. Further according to this embodiment, three of the four through-holes 110a-c receive such a threaded L-clamp. The L-clamps 130 fixedly engage the underside 126 of the tabletop or countertop 122 in a clamping relation by tightening them with wing nuts 140. As shown in FIG. 1 and FIG. 3, the through-holes 110a-d are offset from the peripheral edges 124a, 124b of the slab member 120 thereby forming adapter regions 120a, 120b defined by the peripheral area of the slab member 120 disposed between the through-holes 110a, 110b, 110c and the peripheral edges 124a, 124b.

As shown in FIG.3, a hand-cranked grinder device 300, or other similar device, may be mounted to the slab member 120 at the adaptor region 120a in a clamping relation, i.e. a fixed relation. Specifically, the grinder 300 includes a built-in C-clamp 310, which engages the adaptor region 120a so that the hand-crank 320 can be operated with the grinder 300 fixed in an upright orientation. Accordingly, the grinder 300 can be mounted to the tabletop or countertop 122 without the need for engaging the grinder 300 with the top surface of the tabletop or countertop 122, thereby eliminating the possibility of marring or otherwise damaging the tabletop or countertop 122. Furthermore, the embodiment 100 engages two adjacent sides 122a, 122b of the tabletop or countertop 122, which allows the embodiment 100 to resist slippage when the hand-crank 320 is operated.

The area of the slab member 120 disposed between all of the threaded L-clamps 130 defines a cutting region 120z suitable for use as a cutting board. Accordingly, foods may be cut in the cutting region 120z and transferred to a device 300 mounted on the slab member's adaptor region 120a or 120b without passing over exposed tabletop or countertop 122.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

Having thus described the invention, it is now claimed:

I/we claim:

1. A protective device for mounting to a tabletop or countertop, comprising:
a slab member having at least three corner regions, the slab member being adapted to overlay at least a portion of a tabletop or countertop;
a plurality of clamping members receivable by a plurality of the at least three corner regions, wherein the clamping members are adapted to fixedly engage the slab member with the tabletop or countertop in a clamping relation;
an adapter region comprising a portion of the peripheral area of the slab member disposed between one or more of the plurality of clamping members and one or more peripheral edges of the slab member, wherein the adapter region is configured to receive a mountable food preparation device in a clamping relation; and
a cutting region comprising a portion of the slab member adjacent to the adapter region, wherein the cutting region is configured to receive one or more blades in a cutting relation while protecting the underlying tabletop or countertop from the one or more blades.

2. The protective device of claim 1, wherein the peripheral edges of the slab member generally define one or more of a rectangle, triangle, or an irregular shape.

3. The protective device of claim 1, wherein the plurality of clamping members comprises two, three or four clamping members.

4. The protective device of claim 1, wherein the clamping members comprise one or more of a threaded L-clamp, a C-clamp, or a toggle clamp.

5. The protective device of claim 1, wherein the slab member comprises one or more of wood, butcher-block, polyethylene, polypropylene, high-density polyethylene, tetrafluoroethylene, polycarbonate, or polyethyleneterephthalate.

6. A protective device for mounting to a tabletop or countertop, comprising:
a slab member having at least three corner regions, the slab member being adapted to overlay at least a portion of a tabletop or countertop in a protective relation;
a means for fixedly engaging the slab member with the tabletop or countertop; and
a means for the slab member to receive a mountable food preparation device in a fixed relation.

7. The protective device of claim 6, wherein the means for fixedly engaging the slab member comprises one or more of a threaded L-clamp, a C-clamp, or a toggle clamp.

8. The protective device of claim 6, wherein the slab member comprises one or more of wood, butcher-block, polyethylene, polypropylene, high-density polyethylene, tetrafluoroethylene, polycarbonate, or polyethyleneterephthalate.

9. A protective device for mounting to a tabletop or countertop, comprising:
a slab member having at least three corner regions, the slab member being adapted to overlay at least a portion of a tabletop or countertop;
a plurality of position-fixing members disposed at a plurality of the at least three corner regions, wherein the position-fixing members are adapted to fixedly engage the slab member with the tabletop or countertop in a fixed relation; and
an adapter region comprising a portion of the peripheral area of the slab member disposed between one or more of the plurality of position-fixing members and one or more peripheral edges of the slab member, wherein the adapter region is configured to receive a mountable food preparation device in a clamping relation.

10. The protective device of claim 9, further comprising a cutting region comprising a portion of the slab member adjacent to the adapter region, wherein the cutting region is configured to receive one or more blades in a cutting relation while protecting the underlying tabletop or countertop from the one or more blades.

11. The protective device of claim 9, wherein the plurality of position-fixing members comprise one or more of a threaded L-clamp, a C-clamp, or a toggle clamp.

12. The protective device of claim 9, wherein the slab member comprises one or more of wood, butcher-block, polyethylene, polypropylene, high-density polyethylene, tetrafluoroethylene, polycarbonate, or polyethyleneterephthalate.
